(19) United States
(12) Patent Application Publication
(10) Pub. No.: US 2006/0182492 A1
(43) Pub. Date: Aug. 17, 2006

(54) Draw-wedge fasteners

(75) Inventor: Adam J. Keller, Neenah, WI (US)

Correspondence Address: WILHELM LAW SERVICE, S.C., 100 W LAWRENCE ST, THIRD FLOOR, APPLETON, WI, 54911, US

(73) Assignee: Adam's Specialty Products, LLC, Neenah, WI (US)

(21) Appl. No.: 11/343,534

(22) Filed: Jan. 31, 2006

Related U.S. Application Data
(60) Provisional application No. 60/648,899, filed on Feb. 1, 2005.

(51) Int. Cl. F16B 7/04; F16B 13/04

(52) U.S. Cl. 403/170; 411/32; 403/337; 411/389

(57) ABSTRACT

A draw-wedge fastener assembly has a draw plug, an anchor body, and a bolt which slidingly and rotatably extends through the anchor body, and threadedly extends through and engages the draw plug. The draw plug has first and second expandable terminal ends. The anchor body has a first, generally flat, end surface at a first end, and a generally tapered second end. One of the expandable ends of the draw plug interfaces with and expands over the tapered end of the anchor body. The other one of the expandable ends of the draw plug expands as the bolt passes therethrough.

### CROSS REFERENCE TO RELATED APPLICATIONS

This application is a Non-Provisional Application, claiming priority under 35 U.S.C. 119(e) to U.S. Provisional Application Ser. No. 60/648,899, filed Feb. 1, 2005, which is incorporated herein by reference in its entirety.

### BACKGROUND

The present invention relates generally to hardware-type devices and fasteners, and more particularly, to expanding-type fasteners and connectors.

Square, round, extruded and other tubing is used in, for example, furniture, construction, and enclosure type structures such as animal housing cages, display cases, and/or others. Tubing is a desirable structural material for many such applications as it can be relatively strong while being relatively inexpensive, relatively light, and relatively durable.

However, attaching various pieces of tubing to other various pieces of tubing can prove relatively challenging in some instances. As one example, when using typical attachment hardware such as bolts and nuts, the integrity of the tubing pieces can be compromised. Namely, when a bolt extends transversely through a piece of tubing, and a nut is correspondingly threaded onto the bolt, over-tightening the bolt and/or nut can impart a clamping force, upon the outer walls of the tubing, sufficiently great that the respective outer walls of the tubing collapse toward each other. Thus, the tubing is pinched, partially collapsed, and/or otherwise compromised at or adjacent the location on the tubing through which the bolt extends.

When tubing is pinchingly compromised in this manner, the integrity of the strength of the tubing is correspondingly compromised. Compromising the strength of a piece of tubing can prove dangerous or hazardous, especially when the tubing is used as part of a load bearing assembly such as a display case, an animal housing enclosure, and/or others.

Other tubing connectors are designed more specifically to connect pieces of tubing to each other. These tubing connectors e.g. insert into the pieces of tubing and apply pressure against respective inner circumferential surfaces of the tubing pieces. However, typically, such tubing connectors apply pressure to the inner circumferential surface of a piece of tubing at generally one circumferential locus, e.g. a single circumferential attachment locus, of the respective piece of tubing. Under certain circumstances, and/or under sufficient loads, the frictional attachment force realized at the single circumferential attachment locus is insufficient in magnitude to resist, for example, forces which urge the hardware out of the tubing, and the attachment hardware pulls outwardly from the respective piece of tubing.

Also, cam-lock devices can be use as tubing attachment hardware. Typically, a post which locks with the locking cam is inserted into, or rotatably housed in, a plug and the plug is then e.g. press fit into a piece of tubing. The locking cam is inserted into another piece of tubing, whereby a user can insert the locking post into the locking cam, rotate the cam, and correspondingly lock the two pieces of tubing to each other. Again, under certain circumstances, and/or under sufficient loads, the frictional attachment force realized at the interface of the plug and the inner circumferential tubing surface is insufficient in magnitude to resist corresponding hardware withdrawal forces, and the attachment hardware, e.g. plug, pulls outwardly from the respective piece of tubing.

It is desirable, therefore, to provide tubing attachment hardware and devices which provide a relatively greater attachment force than those typically used. Accordingly, it is desirable to provide tubing attachment hardware and devices which provide an outwardly expanding attachment force at multiple circumferential attachment loci along the length of a piece of tubing. It can prove desirable to provide tubing attachment hardware and devices which include a draw plug with two outwardly expandable terminal ends, whereby the draw plug is adapted and configured to provide an outwardly expanding frictional attachment force at multiple circumferential attachment loci along the length of a piece of tubing.

### SUMMARY

This invention provides a draw-wedge fastener assembly which has a draw plug, an anchor body, and a bolt which slidingly and rotatably extends through the anchor body, and threadedly extends through the draw plug. The draw plug has first and second expandable ends. The anchor body has a first, generally flat, end surface at a first end, and a generally tapered second end. One of the expandable ends of the draw plug interfaces with and expands over the tapered end of the anchor body. The other one of the expandable ends of the draw plug expands as the bolt passes therethrough.

In a first family of embodiments, the invention comprehends a draw-wedge fastener, comprising: (a) an anchor body having a length and a bore extending therethrough, along the length thereof; (b) a draw plug having a length, first and second ends, and a bore extending therethrough, along the length thereof; the bore of the draw plug generally coaxially aligned with the bore of the anchor body; and (c) a bolt having a bolt head and a length and extending axially through the entire length of the bore of the anchor body and at least partially through the length of the bore of the draw plug; and wherein the anchor body is positioned generally between the draw plug and the bolt head, the draw plug movable between a first position and a second position, when the draw plug is in such first position, the draw plug is relatively axially regressed with respect to the anchor body and when the draw plug is in such second position, the draw plug is relatively axially advanced with respect to the anchor body, the draw plug in the second position generally defining relatively outwardly flared first and second ends.

In some embodiments, at least one of the first and second ends of the draw plug has a recess extending axially thereinto.

In some embodiments, the anchor body includes a tapered end, the end recess of the draw wedge fastener adapted and configured to slidingly receive the tapered end of the anchor body therein.

In some embodiments, one of the first and second ends of the draw plug includes a plurality of deflectable tabs extending axially therefrom.

In some embodiments, the draw-wedge fastener is inserted into a piece of tubing and wherein each of the first and second ends of the draw plug interfaces an inner circumferential surface of such piece of tubing.

In some embodiments, at least one of the first and second ends of the draw plug has void extending axially thereinto, such void defining an outer perimeter which is generally defined by a plurality of elongate ramped surfaces.

In some embodiments, ones of the plurality of ramped surfaces are generally deflectable.

In a second family of embodiments, the invention comprehends a draw-wedge fastener, comprising: (a) an anchor body having a length, a bore extending axially therethrough, and first and second ends, the first end of the anchor body defining a generally planar shoulder thereupon which is generally perpendicular to the bore, the second end defining a generally tapering outer surface thereof; (b) a draw plug adapted and configured to axially advance toward and regress from the anchor body, having a length, first and second ends, and a bore extending therethrough, each of the first and second ends of the draw plug being radially expandable, (c) a bolt having extending axially and rotatably through the anchor body and axially into the draw plug, the bolt mechanically engaging the draw plug so that when the bolt is rotated in a first direction of rotational travel, the draw plug axially advances toward the anchor body and when the bolt is rotated in a second, opposite, direct of rotational travel, the draw plug axially regresses from the anchor body.

In some embodiments, at least one of the first and second ends of the draw plug has a recess extending axially thereinto, the end recess of the draw wedge fastener adapted and configured to receive the tapering outer surface of the anchor body therein.

In some embodiments, the draw wedge fastener is adapted and configured to slidingly receive the tapering outer surface of the anchor body therein.

In some embodiments, the one of the first and second ends of the draw plug includes a plurality of resiliently flexible tabs extending therefrom.

In some embodiments, the invention comprehends a tubing assembly comprising a draw-wedge fastener.

In some embodiments, the tubing assembly is an animal housing enclosure.

In some embodiments, the tubing assembly is a table.

In a third family of embodiments, the invention comprehends a draw-wedge fastener, comprising: (a) an anchor body having a length, a bore extending axially therethrough, and a generally tapered end; (b) a draw plug having a length, a bore extending axially therethrough, and first and second ends; and (c) a bolt having extending axially and rotatably through the anchor body and axially into the draw plug, the first end of the draw plug having a recess extending thereinto, the recess adapted and configured to slidingly accept the generally tapered end of the anchor body therein, the second end of the draw plug including a plurality of deflectable tabs extending axially outwardly therefrom.

In some embodiments, the bolt is mechanically engaging the draw plug so that when the bolt is rotated in a first direction of rotational travel, the draw plug axially advances toward the anchor body and when the bolt is rotated in a second, opposite, direct of rotational travel, the draw plug axially regresses from the anchor body.

In some embodiments, the recess defining an outer which is generally defined by a plurality of elongate ramped surfaces.

### BRIEF DESCRIPTION OF THE DRAWINGS

FIG. 1A shows a pictorial view of a first embodiment of tubing assemblies of the invention.

FIG. 1B shows a pictorial view of a second embodiment of tubing assemblies of the invention.

FIG. 1C shows a pictorial view of a third embodiment of tubing assemblies of the invention.

FIG. 2A shows an enlarged pictorial view of a draw-wedge fastener assembly, as a portion of the tubing assembly of FIG. 1A indicated at the dashed circle FIG. 2A of FIG. 1A, and as viewed from inside the tubing assembly.

FIG. 2B shows an enlarged pictorial view of a draw-wedge fastener assembly, as a portion of the tubing assembly of FIG. 1B indicated at the dashed circle FIG. 2B of FIG. 1B, and as viewed from inside the tubing assembly.

FIG. 2C shows an enlarged pictorial view of a draw-wedge fastener assembly, as a portion of the tubing assembly of FIG. 1C indicated at the dashed circle FIG. 2C of FIG. 1C, and as viewed from inside the tubing assembly.

FIG. 3A shows an exploded view of the draw-wedge fastener assembly of FIG. 2A.

FIG. 3B shows an exploded view of the draw-wedge fastener assembly of FIG. 2B.

FIG. 4A shows an exploded, pictorial, view of a second embodiment of draw-wedge fastener assemblies of the invention.

FIG. 4B shows an exploded, pictorial, view of a third embodiment of draw-wedge fastener assemblies of the invention.

FIG. 4C shows an exploded, pictorial, view of a fourth embodiment of draw-wedge fastener assemblies of the invention.

FIG. 5A shows an enlarged, pictorial, view of a first embodiment of draw plugs of the invention.

FIG. 5B shows an end elevation view of the draw plug of FIG. 5A.

FIG. 5C shows an enlarged, pictorial, view of a second embodiment of draw plugs of the invention.

FIG. 5D shows an end elevation view of the draw plug of FIG. 5C.

FIG. 5E shows an enlarged, pictorial, view of a third embodiment of draw plugs of the invention.

FIG. 5F shows an end elevation view of the draw plug of FIG. 5E.

FIG. 6 shows an enlarged, pictorial, view of the anchor body assembly of FIG. 4A.

FIG. 7A shows a cross-sectional view of a first exemplary embodiment of draw plugs and anchor bodies of the invention.

FIG. 7B shows a cross-sectional view of a second exemplary embodiment of draw plugs and anchor bodies of the invention.

FIG. 8 shows a cross-sectional view of the draw plug and anchor body of FIG. 7A, used in combination with a bolt and washer.

FIG. 9 shows a cross-sectional view of the draw-wedge fastener assembly of FIG. 2A, taken at the dashed-arrow line FIG.9-FIG.9 of FIG. 2A.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

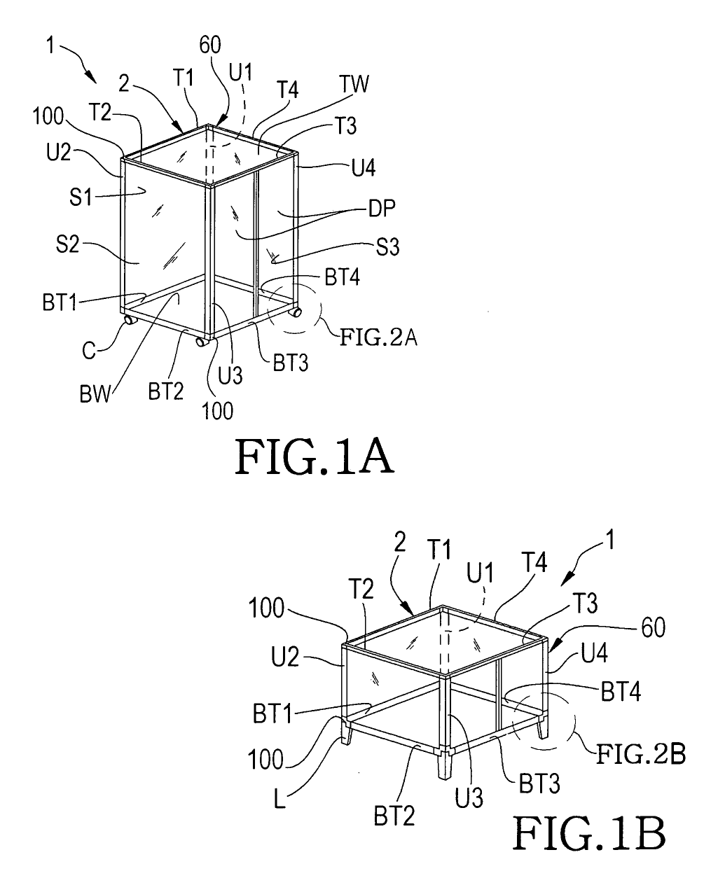

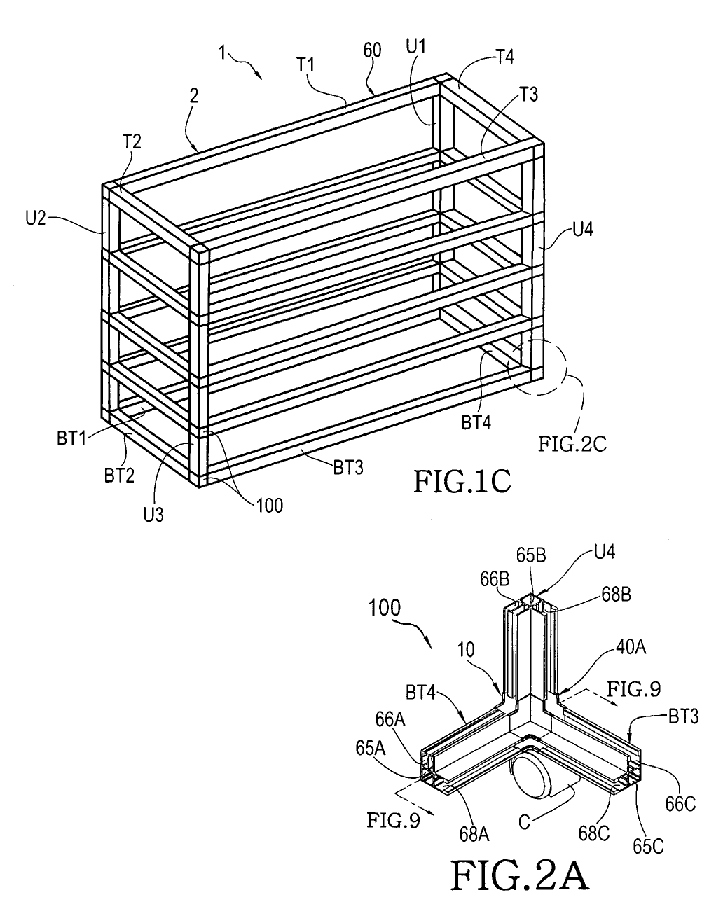

FIG. 1A shows a first embodiment of tubing assemblies of the invention. In a typical implementation of the invention, a tubing assembly 1 includes a tubing frame 2 which in turn includes a plurality of tubing members 60. Various tubing members 60 are connected to each other by way of draw-wedge fasteners, described in greater detail elsewhere herein, and thereby generally define draw-wedge tubing interfaces 100 proximate the respective points of intersection of the tubing members and draw-wedge fasteners. In addition, tubing assembly 1 includes, for example, a plurality of enclosure panels, e.g. top wall “TW,” bottom wall “BW,” sidewalls S1, S2, S3, and door panels DP.

Referring to FIGS. 1A, 1B, and 1C, tubing assembly 1 contemplates a variety of structures and apparatus which include, use, or otherwise utilize, for example, pieces of tubing, piping, and/or other materials which have cavities or voids, and are attached to other pieces of tubing, piping, and/or other materials which have cavities or voids, namely various tubing members 60. Examples of specific end-product uses of tubing assembly 1 include, but are not limited to, animal housing cages, display cases, furniture, and/or others which include non-tubing or piping materials which have cavities or voids.

Exemplary of such non-tubing or piping materials with suitable cavities or voids includes, but is not limited to walls such as, cement, brick, rock, other masonry, stucco, drywall, gypsum, sheet-rock, wooden, metallic, and/or other walls, which have a suitably sized hole drilled thereinto, or other suitably sized aperture, cavity or void, adapted and configured to receive a draw-wedge fastener therein, wherein the draw-wedge fastener is suitable for use as an e.g. hanging or other supporting structure.

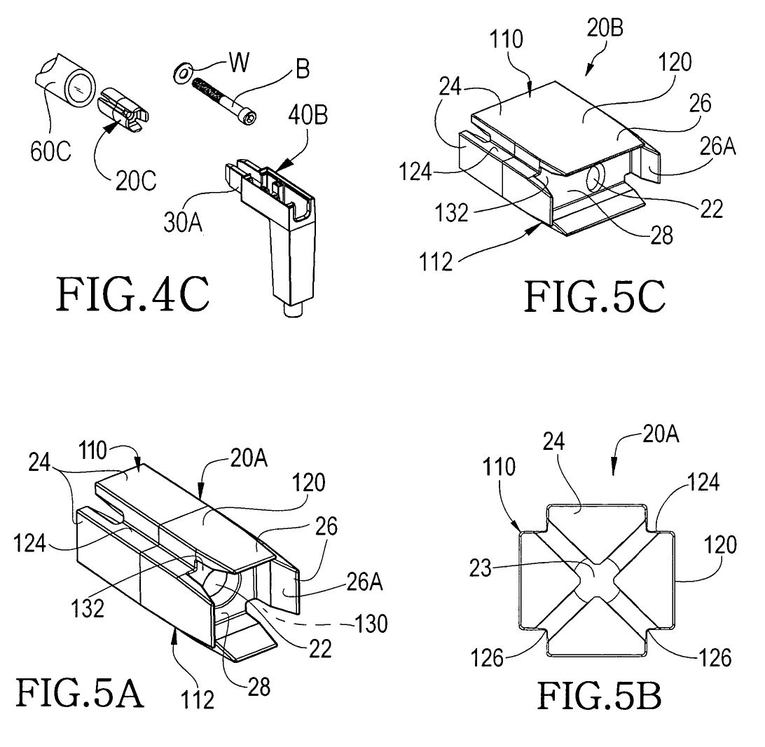

Tubing frame 2 includes a plurality of tubing members 60, which communicate with each other, which collectively provide support, load bearing function, and attachment structure, for the remainder of the assemblage of tubing assembly 1. Various ones of tubing members 60, which in combination generally define tubing frame 2, include, but are not limited to, top tubing members T1, T2, T3, T4, bottom tubing members BT1, BT2, BT3, BT4, upright, corner, tubing members U1, U2, U3, U4, as well as tubing member 60A (FIG. 4A), tubing member 60B (FIG. 4B), tubing member 60C (FIG. 4C), and/or others.

Ones of tubing members 60 are attached to, connected to, and/or otherwise interface with, respective other ones of tubing members 60, by way of draw-wedge fastener assemblies 10 of the invention. Draw-wedge fastener assemblies 10 include various cooperating and communicating components such as e.g. draw plug 20A, 20B, 20C, anchor body assemblies 40A, 40B, 40C, and 40D, and or others, which in combination are adapted and configured to, for example, wedge into or against, frictionally engage with, and/or otherwise hold against, various pieces of tubing, piping, and/or other relatively rigid members which have suitable openings or apertures therein.

The communicating portions of the draw-wedge fastener assemblies 10, along with respective tubing member 60, generally define draw-wedge tubing interfaces 100. Such draw-wedge tubing interfaces 100 are typically located at, for example, corners of the tubing frame 2, where respective tubing members 60 intersect at non 180-degree angles, non-corner interfaces such as where respective tubing members 60 insect at 180-degree, i.e. straight-line linear, angles and thus form e.g. lengthwise splices, extensions, and/or other portions of tubing frame 2.

Referring to various tubing members 60, each of top tubing members T1, T2, T3, T4, is an elongate, rigid member with a length defined between two terminal ends, an outer surface which defines outer surface characteristics, and a through-bore which extends axially through the length of the respective tubing member. The outer surface characteristics of top tubing members T1, T2, T3, T4, enable ones of the tubing members to generally interface with, hold, attach, and/or otherwise communicate with, other components of tubing assembly 1.

Top tubing members T1, T2, T3, T4, in combination, define the uppermost portion of tubing frame 2. Respective ones of the terminal ends of top tubing members T1, T2, T3, T4 communicate with other ones of the of the terminal ends of adjacent ones of top tubing members T1, T2, T3, T4. Thus, in the complete assemblage of tubing frame 2, top tubing members T1, T2, T3, T4, as viewed from above, generally define a rectangular perimeter which includes first and second pairs of parallel tubing members, whereby the first pair is generally perpendicular to the second pair.

Accordingly, as exemplarily illustrated in FIGS. 1A, 1B, and 1C, top tubing members T1 and T3 extend generally parallel to, and laterally spaced from, each other. And, top tubing members T2 and T4 extend generally parallel to, and laterally spaced from, each other. Respective elements of top tubing members T1, T3 extend generally perpendicularly away from, and/or toward, corresponding ones of top tubing members T2, T4.

Each of bottom tubing members BT1, BT2, BT3, BT4, is an elongate, rigid member with a length defined between two terminal ends, an outer surface which defines outer surface characteristics, and a through-bore which extends axially through the length of the respective tubing member. The outer surface characteristics of bottom tubing members BT1, BT2, BT3, BT4, enable ones of the tubing members to generally interface with, hold, attach, and/or otherwise communicate with, other components of tubing assembly 1.

Bottom tubing members BT1, BT2, BT3, BT4, in combination, define the lowermost portion of tubing frame 2. Respective ones of the terminal ends of bottom tubing members BT1, BT2, BT3, BT4 communicate with other ones of the of the terminal ends of adjacent ones of bottom tubing members BT1, BT2, BT3, BT4. Thus, in the complete assemblage of tubing frame 2, bottom tubing members BT1, BT2, BT3, BT4, as viewed from above, generally define a rectangular perimeter which includes first and second pairs of parallel tubing members, whereby the first pair is generally perpendicular to the second pair.

Accordingly, as exemplarily illustrated in FIGS. 1A, 1B, and 1C, bottom tubing members BT1 and BT3 extend generally parallel to and laterally spaced from each other. And, bottom tubing members BT2 and BT4 extend generally parallel to and laterally spaced from each other. Respective elements of bottom tubing members BT1, BT3 extend generally perpendicularly away from, and/or toward, corresponding ones of bottom tubing members BT2, BT4.

Each of upright tubing members U1, U2, U3, U4, is an elongate, rigid member with a length defined between two terminal ends, an outer surface which defines outer surface characteristics, and a through-bore which extends axially through the length of the respective tubing member. The outer surface characteristics of upright tubing members U1, U2, U3, U4, enable ones of the tubing members to interface with, hold, attach, and/or otherwise communicate with, other components of tubing assembly 1.

Upright tubing members U1, U2, U3, U4, in combination, at least partially define the lateral, outer perimeter portion of tubing frame 2 at e.g. upright corners of the frame. Respective ones of the terminal ends of upright tubing members U1, U2, U3, U4 communicate with, and span generally vertically between, e.g. (i) corresponding generally intersecting points of ones of top tubing members T1, T2, T3, T4, and (ii) corresponding intersecting points of ones of bottom tubing members BT1, BT2, BT3, BT4.

Thus, as exemplarily illustrated, upright tubing member U1 spans between the general interface of top tubing members T1, T4, and the general interface of bottom tubing members BT1, BT4. Upright tubing member U2 spans between the general interface of top tubing members T1, T2, and the interface of bottom tubing members BT1, BT2. Upright tubing member U3 spans between the general interface of top tubing members T2, T3 and the interface of bottom tubing members BT2, BT3. And upright tubing member U4 spans between the interface of top tubing members T3, T4 and the interface of bottom tubing members BT3, BT4.

Accordingly, the combination of top tubing members T1, T2, T3, T4, bottom tubing members BT1, BT2, BT3, BT4, and upright tubing members U1, U2, U3, U4 generally define tubing frame 2 which is a generally skeletal tubing assembly which at least partially defines the overall shape and configuration of tubing assembly 1.

Top wall “TW” is optionally generally planar, has an upper surface, a lower surface, a length, a width, and outer edges which at least partially define a generally rectangular outer perimeter. The length of top wall “TW” generally corresponds in magnitude to the magnitude of the distance between top tubing members T1, T3. The width of top wall “TW” corresponds generally in magnitude to the magnitude of the distance between top tubing members T2, T4. Top wall “TW” is generally connected to, housed in, and/or otherwise attached to, the remainder of tubing assembly 1 by the interface between top wall “TW” and ones of top tubing members T1, T2, T3, T4.

Bottom wall “BW” is optionally generally planar, has an upper surface, a lower surface, a length, a width, and outer edges which at least partially define a generally rectangular outer perimeter. The length of bottom wall “BW” corresponds generally in magnitude to the magnitude of the distance between bottom tubing members BT1, BT3. The width of bottom wall “BW” corresponds generally in magnitude to the magnitude of the distance between bottom tubing members BT2, BT4. Bottom wall “BW” is generally connected to, housed in, and/or otherwise attached to, the remainder of tubing assembly 1 by the interface between bottom wall “BW” and ones of bottom tubing members BT1, BT2, BT3, BT4.

Sidewall S1 is optionally generally planar, has an inwardly facing surface, an outwardly facing surface, a length, a width, and outer edges which at least partially define a generally rectangular outer perimeter. The length of sidewall S1 corresponds in magnitude to the magnitude of the distance between top and bottom tubing members T1, BT1. The width of sidewall S1 corresponds in magnitude to the magnitude of the distance between upright tubing members U1, U2. Sidewall S1 is generally connected to, housed in, and/or otherwise attached to, the remainder of tubing assembly 1 through interfaces between sidewall S1 and ones of top and bottom tubing members T1, BT1, and upright tubing members U1, U2.

Sidewall S2 is optionally generally planar, has an inwardly facing surface, an outwardly facing surface, a length, a width, and outer edges which at least partially define a generally rectangular outer perimeter. The length of sidewall S2 corresponds in magnitude to the magnitude of the distance between top and bottom tubing members T2, BT2. The width of sidewall S2 corresponds in magnitude to the magnitude of the distance between upright tubing members U2, U3. Sidewall S2 is generally connected to, housed in, and/or otherwise attached to, the remainder of tubing assembly 1 through interfaces between sidewall S2 and ones of top and bottom tubing members T2, BT2, and upright tubing members U2, U3.

Sidewall S3 is optionally generally planar, has an inwardly facing surface, an outwardly facing surface, a length, a width, and outer edges which at least partially define a generally rectangular outer perimeter. The length of sidewall S3 corresponds generally in magnitude to the magnitude of the distance between top and bottom tubing members T4, BT4. The width of sidewall S3 corresponds generally in magnitude to the magnitude of the distance between upright tubing members U1, U4. Sidewall S3 is generally connected to, housed in, and/or otherwise attached to, the remainder of tubing assembly 1 through interfaces between sidewall S3 and ones of top and bottom tubing members T4, BT4, and upright tubing members U1, U4, as is described in greater detail elsewhere herein.

Door panels “DP” are adapted and configured to move between an open position (not illustrated) and a closed position (illustrated in FIG. 1A). In the open position, door panels “DP” at least partially define an entrance, or opening, which enables a user to access the interior, inner, area within tubing assembly 1. Each of Door panels “DP” has an inwardly facing surface, an outwardly facing surface, a length, a width, and outer edges which at least partially define an optionally generally rectangular outer perimeter.

The length of each of door panels “DP” optionally corresponds in magnitude generally to the magnitude of the distance between top and bottom tubing members T3, BT3. The sum of the widths of both of door panels “DP,” e.g. the width of both of door panels “DP” in combination, optionally corresponds in magnitude generally to the magnitude of the distance between upright tubing members U3, U4. Door panels “DP” are pivotably, slidingly, hingedly, and/or otherwise movably attached to, the remainder of tubing assembly 1 by the interfaces between ones of door panels “DP” and ones of top and bottom tubing members T3, BT3, and/or upright tubing members U3, U4.

Ones of top wall “TW,” bottom wall “BW,” sidewalls S1, S2, S3, and door panels DP can be formed from a variety of suitable materials selected, at least in part, based on the intended end use and end use environment of tubing assembly 1. Suitable materials for use in the e.g. wall panels and door panels include, but are not limited to, acrylic, glass, stainless steel wire, stainless steel wire mesh, wood, wood laminates, and/or others.

In the embodiment illustrated in FIG. 1A, tubing assembly 1 further includes a plurality of casters or wheels e.g. castors “C.” Each of castors “C” is attached to the bottom-most portion of tubing assembly 1, adjacent or otherwise proximate the bottom corners of tubing frame 2.

The embodiment of FIG. 1B does not include castors “C.” Rather, bottom wall “BW” is vertically spaced from the ground, floor, or other underlying support surface, by one or more legs “L.”

The embodiment of FIG. 1C is generally devoid of any support structure which vertically spaces the bottom portion thereof from the ground, floor, or other underlying support surface. In other words, the bottom, generally planar, surface of tubing assembly 1, shown in FIG. 1C, sits directly atop and interfaces with the ground, floor, or other underlying support surface.

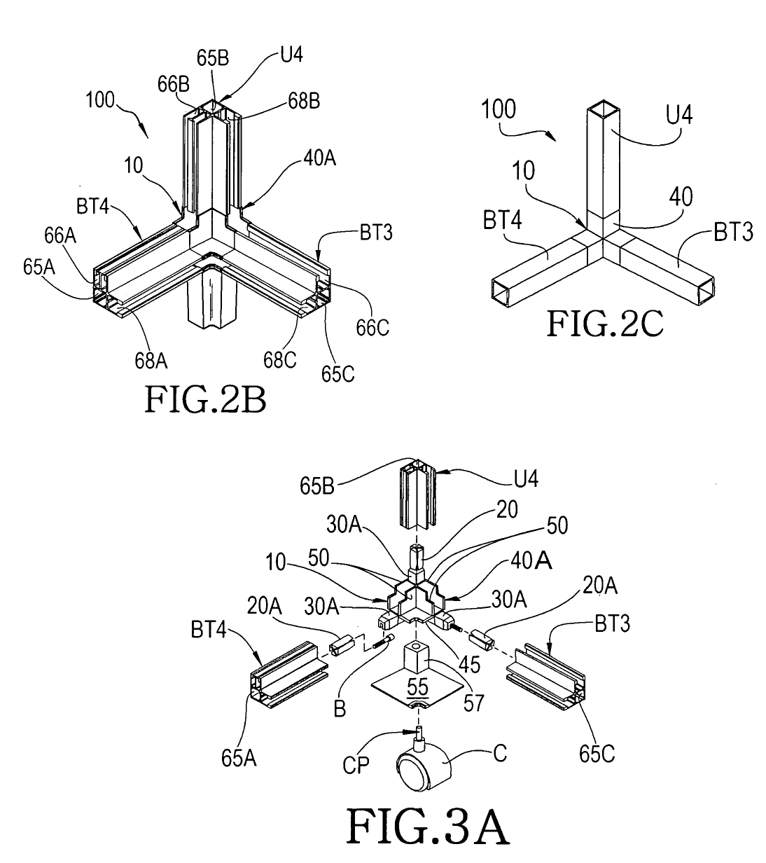

Referring now to FIGS. 2A, 2B, and 2C, draw-wedge tubing interface 100 generally defines a region of intersection, coupling, and/or other attachment of, for example, multiple ones of tubing members 60 to each other, such as the exemplary top tubing members T1, T2, T3, T4, bottom tubing members BT1, BT2, BT3, BT4, and upright, corner, tubing members U1, U2, U3, U4, for example where bottom tubing members BT3 and BT4 meet upright tubing member U4.

FIG. 2A shows an enlarged pictorial view of a portion of a draw-wedge tubing interface 100 which includes a first embodiment of draw-wedge fastener assemblies 10 of the invention. Namely, FIG. 2A shows a pictorial view of draw-wedge fastener assembly 10, which includes anchor body assembly 40A, at the interfacing portions of bottom tubing members BT3, BT4, and upright tubing member U4. Namely, FIG. 2A shows an enlarged pictorial view of the draw-wedge tubing interface 100, indicated at the dashed circle labeled “FIG. 2A” in FIG. 1A, as viewed from inside of tubing assembly 1.

Anchor body assembly 40A is adapted and configured to join, at least in combination with other components of draw-wedge fastener assembly 10, multiple tubing members to each other, and respective ones of e.g. top tubing members T1, T2, T3, T4, bottom tubing members BT1, BT2, BT3, BT4, and upright, corner, tubing members U1, U2, U3, U4 communicating therewith.

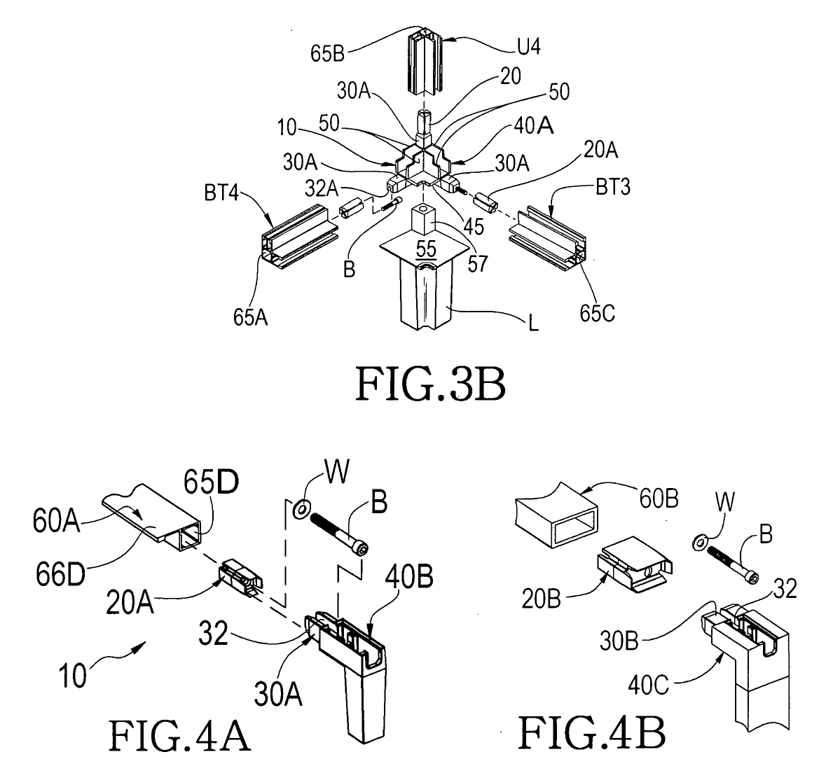

Referring now to FIGS. 2A and 3A, draw-wedge fastener assembly 10 further includes at least one draw plug 20A, anchor body 30A, bolt “B,” and washer “W” (FIG. 4A). In the exemplary embodiment of FIGS. 2 and 3, the draw-wedge fastener assembly 10 also includes anchor bottom plate 45, side gussets 50, bottom cap 55 with cap projection 57, and castor “C” with castor projection “CP.”

Bolt “B” has a bolt shaft, a bolt head, a length, and a width which defines a bolt diameter. In some embodiments, the bolt shaft has a threaded portion and a non-threaded portion. Those skilled in the art are well aware of suitable hardware for use as bolt “B” including, but not limited to, bolts, shoulder bolts, cap-head bolts, cap-head screws, screws, and others. In some embodiments, bolt “B” is used in combination with one or more washer, e.g. washer “W” (FIG. 4A).

Referring now to FIGS. 2B and 3B, FIG. 2B shows enlarged pictorial view of the draw-wedge tubing interface 100, indicated at the dashed circle labeled “FIG. 2B” in FIG. 1B, as viewed from inside of tubing assembly 1. FIG. 3B shows an exploded view of the embodiment of FIG. 2B.

Like the draw-wedge tubing interface 100 of FIG. 2A, the draw-wedge tubing interface 100 of FIG. 2B includes anchor body assembly 40A. However, the draw-wedge tubing interface 100 FIG. 2B includes leg “L” in lieu of caster “C.” Leg “L” is integral with, optionally removably attached to, e.g. bottom cap 55.

FIG. 1C shows another embodiment of draw-wedge tubing interfaces 100 of the invention. Draw wedge fastener assembly 10, of FIG. 1C, is adapted and configured for use with tubing which has, for example, a generally square extrusion profile and thus perimeter, sometimes used in e.g. the components of various tubular, modular, optionally end-user assembled, furniture, such as tables, desks, display cases, electronic equipment or accessory racks, and/or others.

Referring now to FIGS. 3A, 3B, 4A, 5A, 5B, 7A, 7B, 8 and 9, draw plug 20A is a generally elongate, rectangular box-type, member, and includes a plurality of sidewalls 120, optionally one cylindrical sidewall 120, at least one insert tab 24, and at least one ramp tab 26.

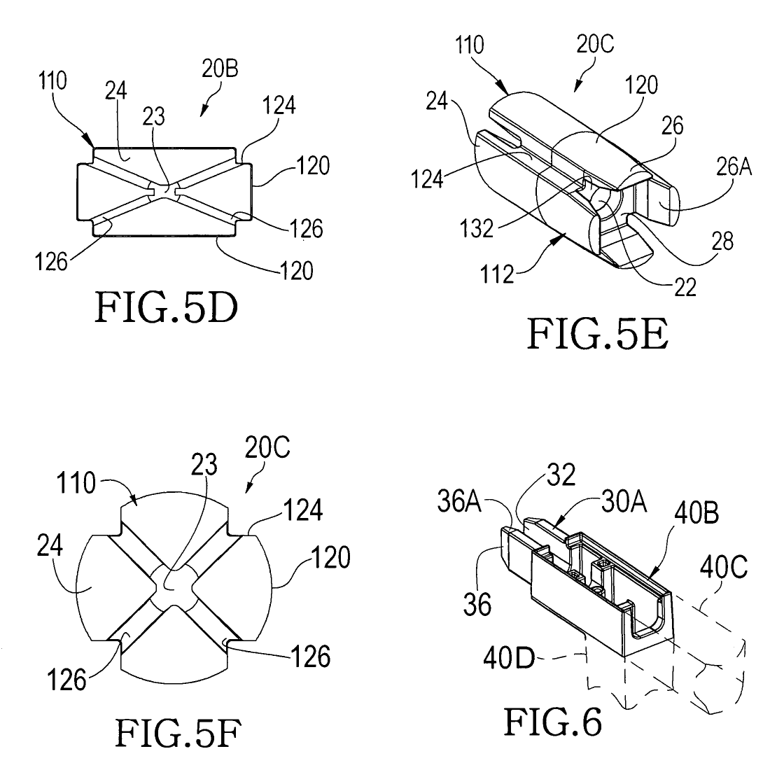

Draw plug 20A has first and second terminal ends, namely ends 110 and 112. Each of the ends 110, 112 of draw plug 20A is adapted and configured to e.g. at least partially flex outwardly and/or to radially expand. The outer perimeters of first and second ends 110, 112 appear generally square when viewed from an end view (FIG. 5B).

Each of the sidewalls 120 defines a generally planar outwardly facing surface. Respective edges of ones of the plug sidewalls 120 interface with corresponding edges of other respective ones of the plug sidewalls 120. The four plug sidewalls 120, and the first and second ends 110,112, in combination, generally define the overall box-type structure of draw plug 20A.

The portions of plug sidewalls 120 which intersect each other, namely the edge corners, have depressions, voids, and/or cavities, namely corner depressions 124 which extend thereinto. Corner depressions 124 are generally defined by the void space between perpendicularly intersecting planar surfaces which extend from lateral edges of adjacent ones of plug sidewalls 120. Thus, corner depressions 124 are elongate rabbet-type, L-shaped, V-shaped, grooves which extend along the length of draw plug 20A, at each corner between respective plug sidewalls 120.

Threaded bore 22 extends medially through a major portion of the length of the main body portion of draw plug 20A, optionally less than the entirety of the length of the main body portion of draw plug 20A. In other words, threaded bore 22 extends generally between the first and second ends of the main body portion of draw plug 20A.

A first end of threaded bore 22 extends into, and thus threaded bore 22 begins at, a first end of draw plug 20A, or adjacent or otherwise proximate thereto. A second end of threaded bore 22 opens into a first end of end bore 23.

End bore 23 extends along the remainder of the length of draw plug 20A and is generally coaxial with threaded bore 22. Namely, end bore 23 extends from its point of intersection with threaded bore 22 to, adjacent or otherwise proximate, a second end of draw plug 20A. Accordingly, threaded bore 22 and end bore 23 in combination extend generally medially through draw plug 20A and generally along a major portion of, optionally the entirety of, the length of the draw plug.

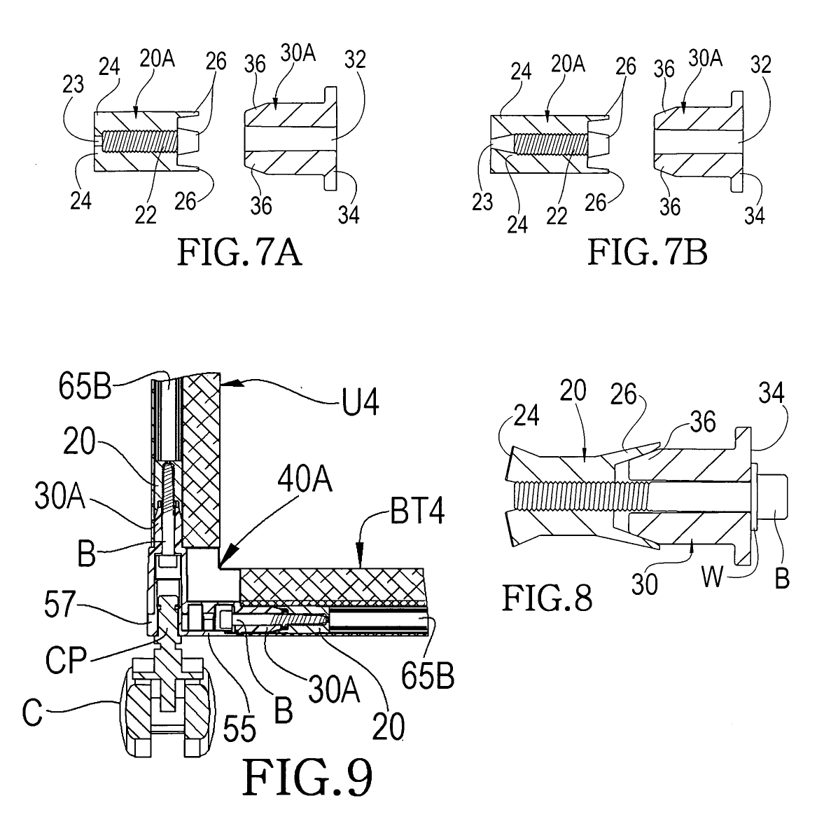

In some embodiments, end bore 23 has a generally constant diameter along the length thereof. In such embodiments, magnitude of the end bore 23 diameter is relatively lesser than the magnitude of the diameter of threaded bore 22 (FIG. 7A).

In some embodiments, end bore 23 has first and second openings of different diameters, respectively. Namely, in some embodiments, end bore 23 conically or otherwise tapers downwardly, from a relatively greater diameter at the portion of end bore 23 which is adjacent threaded bore 22, to a relatively lesser diameter and the other end of the end bore 23 (FIG. 7B).

Draw plug 20A includes at least one insert tab 24 at an end thereof. Namely, insert tabs 24 are proximate one of the first and second ends 110,112, of draw plug 20A. Each insert tab 24 is flexible, optionally resiliently flexible, optionally deflectable, yet sufficiently durable so as to provide a suitable mechanical interface to e.g. wedge and hold the draw plug against, for example an inner surface of a tubing member.

A portion of each of insert tabs 24 projects inwardly into draw plug 20A and defines the inwardly-facing surface, e.g. of end bore 23, as illustrated in the cross-section view of FIG. 7A. Thus, the inwardly-facing surface of end bore 23 is defined by innermost portions of insert tabs 24, collectively.

Stated another way, insert tabs 24 extend axially outwardly away from the main body portion of draw plug 20A. Ones of insert tabs 24 extend generally parallel to respective other ones of insert tabs 24. Accordingly, insert tabs 24 are generally finger-like projections. The portions of insert tabs 24 which are located generally most inwardly into the draw plug generally define the outermost perimeter of end bore 23.

As illustrated in FIGS. 5A and 5B, individual insert tabs 24 generally define separate and distinct end portions of the main body of the plug. The individual tabs 24 are separated from each other by tab spaces 126 which generally perpendicularly intersect, or otherwise communicate, with corner depressions 124.

Namely, the end 110 of draw plug 20A which includes insert tabs 24 appears generally square-like in perimeter as viewed from an end view, such as that illustrated in FIG. 5B. The square-like perimeter of end 110 is generally defined by, for example, outwardly facing surfaces of the e.g. four insert tabs 24, in combination.

The particular number and configuration of tab spaces 126 which are utilized corresponds to the number of insert tabs 24 in the particular embodiment, as well as the particular configuration of the various tabs 24. In some embodiments, such as those which include more than two insert tabs 24, the various tabs 24 are separated by, for example, at least three tab spaces 126. Referring specifically to the embodiment of FIG. 5B, in embodiments which include four insert tabs 24, end 110 includes first and second intersecting tab spaces 126, or first, second, third, and fourth, intersecting or interfacing tab spaces 126.

Tab spaces 126 can also be described as merely extensions of corner depressions 124, which define relatively greater magnitudes of depression depth. In other words, corner depressions 124, at end 110, extend through the entirety of the thickness dimension of draw plug 20A, thereby defining tab spaces 126 and correspondingly defining insert tabs 24 therebetween.

Accordingly, when viewing end 110 of draw plug 20A, the tab spaces 126 appear generally X-shaped or otherwise intersecting. The particular configurations and orientations of tab spaces 126 correspond to the end-view perimeter shapes of ones of insert tabs 24. Thus, in embodiments in which two tab spaces 126 intersect, such as that of FIG. 5B, the end surfaces of insert tabs 24 define generally triangular perimeters.

Ones of the corners of the triangular perimeter of the insert tab 24 end surface face or point toward corresponding corners on other, corresponding, insert tabs 24. The four inwardly pointing end surface corners of the four insert tabs 24 point, face, or converge toward the opening of end bore 23.

Tab spaces 126, at least partially, enable insert tabs 24 or portions thereof to flex with respect to the remainder of draw plug 20A. The portions of tabs 24 which are proximate the main body portion of draw plug 20A are generally fixed thereto, whereby the distal ends of tabs 24 are adapted and configured to move relatively greater distances than portions of tabs 24 which are relatively more proximate the remainder of draw plug 20A.

As viewed from a side elevation of draw plug 20A, as tabs 24 flex, bend, or otherwise move, the distal ends of tabs 24 move along a generally arcuate travel path, optionally a generally straight line travel path. As observed from an end view of draw plug 20A, namely as directly viewing end 110, as tabs 24 flex, bend, or otherwise move outwardly, the ends and/or other portions of tabs 24 e.g. radially expand outwardly away from e.g. an axis that runs medially and longitudinally through the draw plug 20A.

Referring now to FIG. 5A, draw plug 20A further includes one, optionally a plurality of ramp tabs 26. Ramp tabs 26 extend from the main body of the plug at the other one of the first and second draw plug ends, namely end 112.

Each ramp tab 26 is flexible, optionally resiliently flexible, optionally deflectable, yet sufficiently durable so as to provide a suitable mechanical interface to e.g. wedge and hold the draw plug against, for example an inner surface of a tubing member.

Each of ramp tabs 26 has an inwardly facing surface and an outwardly facing surface. The outwardly facing surfaces of the, for example, four ramp tabs 26 generally define the outer perimeter of end 112 of draw wedge 20A.

As illustrated in FIG. 5A, the inwardly facing surface of ramp tab 26 includes a ramped surface, namely ramped surface 26A (FIG. 5A). Ramped surface 26A slopes or tapers outwardly toward the terminal end and outer surface of ramp tab 26. In other words, as viewed in a side elevation, ramp tab 26 has a thickness dimension of relatively greater magnitude at a first end thereof, and a thickness dimension of a relatively lesser magnitude at a second end thereof which is the outermost terminal end.

In some embodiments, the inwardly facing surface of ramp tab 26 has first and second portions. The first portion of the ramp tab inwardly facing surface extends generally parallel to the outwardly facing surface of ramp tab 26. The second portion of the ramp tab inwardly facing surface is defined by ramped surface 26A and thus extends angularly and taperingly, along optionally a generally straight line travel path, toward the outwardly facing surface of ramp tab 26.

Ones of ramp tabs 26 extend axially outwardly away from the main body portion of draw plug 20A. More particularly, ones of ramp tabs 26 extend axially outwardly away from outwardly facing end surface, namely shoulder 28 of the main body portion of draw plug 20A. In some embodiments, ramp tabs 26 extend axially outwardly away from perimeter edges of the outwardly facing end surface of shoulder 28.

Shoulder 28 is a generally planar surface through which threaded bore 22 extends, whereby the opening of threaded bore 22 is generally defined at a medial portion of shoulder 28. Shoulder 28 generally provides a mechanical interface adapted and configured to cooperate with, for example, various pieces of hardware, namely other components of draw-wedge fastener assembly 10, which is explained in greater detail elsewhere herein.

Shoulder 28 and the inwardly facing surfaces of the ramp tabs 26, in combination, generally define an outer perimeter of a cavity or void, namely pocket cavity 130. Pocket cavity 130 is adapted and configured to house or accept, for example sliding or otherwise house or accept, e.g. portions of anchor body 30A, 30B, or others, therein.

Since ramp tabs 26 includes ramp surfaces 26A thereof, pocket cavity 130 has relatively different opening widths or diameters along various portions of its length dimension. In particular, the opening width dimension of pocket cavity 130 adjacent shoulder 28 has a magnitude which is relatively less than the magnitude of the opening width dimension adjacent the terminal ends of ramp tabs 26, whereby the outer opening of pocket cavity 130 is wider than the base of pocket cavity 130 which is nearest shoulder 28.

Ones of ramp tabs 26 extend generally parallel to respective other ones of ramp tabs 26. Ramp tabs 26 are generally flat, finger-like, projections, and are relatively thinner and more planar than insert tabs 24.

As illustrated in FIG. 5A, ones of ramp tabs 26 are generally separate and distinct entities with respect to each other. The individual ramp tabs 26 are separated from each other by e.g. pocket cavity 130 and by ramp spaces 132 which generally communicate with respective ones of corner depressions 124.

The particular number and configuration of ramp spaces 132, which are utilized, corresponds to the number of ramp tabs 26 in the particular embodiment, as well as the particular configuration of the various ramp tabs 26.

Like tab spaces 126, ramp spaces 132 can also be described as merely extensions of corner depressions 124, having relatively greater magnitudes of depression depth.

In other words, corner depressions 124, at end 112, extend through the entirety of the thickness dimension of draw plug 20A, whereby the corner depressions at end 112 define ramp spaces 132 and in combination with pocket cavity 130 define ramp tabs 26 therebetween.

Ramp spaces 132, at least partially, enable ramp tabs 26 or portions thereof to flex with respect to the remainder of draw plug 20A. The portions of ramp tabs 26 which are proximate the main body portion of draw plug 20A are generally fixed thereto, whereby the distal ends of ramp tabs 26 are adapted and configured to move relatively greater distances than portions of tabs 26 which are relatively more proximate shoulder 28.

As viewed from a side elevation of draw plug 20A, as ramp tabs 26 flex, bend, or otherwise move, the distal ends of tabs 26 move along a generally arcuate travel path, optionally along a generally straight line travel path. As observed from an end view of draw plug 20A, namely as directly viewing end 112, as ramp tabs 26 flex, bend, or otherwise move outwardly, the ends and/or other portions of ramp tabs 26 radially expand outwardly away from e.g. an axis that runs medially and longitudinally through the draw plug 20A.

In some embodiments, such as those illustrated in FIGS. 4B, 5C, and 5D, the draw plug 20B has first and second ends which appear generally non-square rectangular when viewed from an end view. Thus, as desired, such as when pieces of non-square rectangular profile tubing are to be joined to each other, the draw plug 20B has, for example, a relatively greater magnitude of width versus its corresponding magnitude of height. In other words, the overall profile, outer surfaces, and configuration of draw plug 20B, and all other draw plugs, corresponds to the profile, size, and configuration, of the opening into which it is inserted.

In some embodiments, such as those illustrated in FIGS. 4C, 5E, and 5F, draw plug 20C is generally cylindrical, whereby the first and second terminal ends appear generally circular when viewed from an end view.

Accordingly, as desired, such as when round tubing or piping, or other cylindrical members which have generally round end-profiles, are to be joined to each other, the draw plug 20C has, for example, an overall cylindrical structure. In other words, the overall profile, outer surfaces, and configuration of draw plug 20C, and all other draw plugs, corresponds to the profile, size, and configuration, of the opening into which it is inserted.

Other, non-illustrate, embodiments are considered and are well within the scope of the invention, which include any of a variety of other suitable end view configurations, profiles, and outer surface configurations, as desired by the user, such as those with generally triangular end surfaces, and/or other configurations.

Referring now to FIGS. 3A, 3B, 4A, 4B, 6A, 7A, 7B, 8, and 9, draw wedge fastener assembly 10 further includes an anchor body, such as anchor body 30A, 30B, and/or others. Anchor body 30A, 30B includes a main body portion, a shoulder 34, and at least one tapered ramp 36. Namely, anchor body 30A, 30B includes shoulder 34 at a first end thereof, and tapered ramps 36 at a second end thereof. Anchor body 30A, 30B is adapted and configured to cooperate and interface with other components of draw wedge fastener assembly 10, such as draw plugs, bolts “B,” washers “W,” and/or others. In some embodiments, such as those of FIGS. 3A, 3B, 4A, 4B, 6A, 8, and 9, anchor body 30A, 30B is optionally an integral part of a larger assemblage, namely anchor body assembly 40A, 40B, 40C, 40D, and/or others.

Referring now to FIGS. 3A, 3B, 4A, 6A, 7A, 7B, 8, and 9 anchor body 30A is a generally rectangular cross-section, box-type, rigid member with a plurality of sidewalls, and first and second terminal ends which define a length therebetween.

Smooth bore 32 extends axially and medially between the first and second terminal ends, e.g. through the entire length of anchor body 30A, including through shoulder 34 and through and/or axially between tapered ramps 36. In some embodiments, such as those of FIGS. 3A, 3B, 4A, 4B, 6A, and/or others, smooth bore 32 is not a true, circumferentially enclosed, bore. Rather, smooth bore is an e.g. elongate channel with, for example, first, second, and third perimeter walls and an elongate opening extending along at least part of the length thereof.

Shoulder 34 is adapted and configured to cooperatively interface with other parts of draw-wedge fastener assembly 10, such as washer “W,” bolt “B,” and others. Namely shoulder 34 at least partially defines a generally flat surface which is adapted and configured to mechanically interface with e.g. (i) the shoulder or head of a shoulder bolt, (ii) the head of a socket-cap bolt or screw, (iii) a flat, side, surface of washer “W”, and/or (iv) other suitable portions of bolts, screws, washers and/or other hardware.

Regarding specifically the main body portion of anchor body 30A, in some embodiments, anchor body 30A defines a generally rectangular box-type structure which has four closed sidewalls e.g. a generally continuous and enclosed outer circumferential surface, and first and second end walls. Exemplary of a such four-walled anchor body is the anchor body 30A which is vertically positioned, and points upwardly, in FIG. 3B, although only two of the four sidewalls are visible.

Also as illustrated in FIGS. 3A and 6, in some embodiments, anchor body 30A has an elongate opening or channel, which extends along the length of anchor body 30A and opens into smooth bore 32 and the opening which extends through shoulder 34.

In such embodiments, anchor body 30A defines a generally rectangular box-type structure which has three sidewalls which are generally continuous, connected at respective edges to respective ones of each other. The three sidewalls generally define a partially enclosed structure, which defines at least part of the anchor body, which has an open sidewall that generally defines the opening which extends into smooth bore 32.

In other words, anchor body 30A has three sidewalls, generally defining a partially closed or enclosed structure, which include a connecting sidewall and two lateral sidewalls. The connecting sidewall spans between, and connects, corresponding portions of the lateral sidewalls. The portions of the two lateral sidewalls which are distal the connecting sidewall, e.g. the outermost portions of the two lateral sidewalls, are generally parallel to, and spaced from, each other, whereby the space between the outermost portions of the two lateral walls generally defines the width of the open sidewall, and correspondingly defines the maximum potential width of a longitudinal opening which extends along the open sidewall.

In some embodiments, the magnitude of the distance between the two lateral walls of anchor body 30A, e.g. the width of the longitudinal opening in the open sidewall, is somewhat less than the magnitude of the diameter of smooth bore 32. In addition, magnitude of the width of the opening in the open sidewall can be somewhat less than the magnitude of the diameter of bolt “B” which is adapted and configured to be e.g. rotatably housed in smooth bore 32.

The difference in width between the longitudinal opening and the diameter of bolt “B” is such that a user can generally snap-lockingly, laterally, insert bolt “B” through the opening in the open sidewall of anchor body 30A. The user aligns bolt “B” longitudinally with the elongate opening through the open sidewall, and applies a force against the outer circumferential surface of bolt “B” toward anchor body 30A. This lateral inserting force transfers through bolt “B” against the two lateral walls of anchor body 30A, and urges the two lateral walls generally away from each other e.g. relatively further from each other, thereby to enable bolt “B” to slide past the relatively lesser diameter portion of the elongate opening, and correspondingly enables bolt “B” to insert into smooth bore 32.

When bolt “B” is fully, rotatably, housed in smooth bore 32, the outermost portions of the two lateral sidewalls resiliently return to their pre-stressed configuration and the opening width defined between the two lateral sidewalls is again lesser in magnitude than the magnitudes of the diameter of bolt “B.” Thus the lateral sidewalls of anchor body 30A frictionally and/or mechanically resist the removal of bolt “B” from smooth bore 32, whereby bolt “B” is at least partially captured and rotatably housed within smooth bore 32.

Tapered ramps 36, in combination, generally define a tapered end portion of the anchor body 30A, 30B. In some embodiments such as those of FIGS. 4A, 4B, 4C, 6A, and others, three tapered ramps are utilized. In such embodiments, first and second ones of tapered ramps 36 extend in generally parallel directions, with the respective tapered surface tapering outwardly and downwardly toward the other one of the two generally parallel tapered ramps 36. The third tapered ramp 36 extends generally perpendicularly between and connects the first and second tapered ramps 36.

Tapered ramps 36 are adapted and configured to cooperatively interface with draw plug 20A. Namely, tapered ramps 36 have outer surface characteristics which enable the ramps to interface with, slidingly interface with, or otherwise communicate with, for example, ramp tabs 26. Tapered ramps 36 extend downwardly/inwardly toward smooth bore 32, at the end of body 30A which is opposite shoulder 34, whereby the cross-section defined across tapered ramps 36 correspondingly decreases nearer the respective terminal end of anchor body 30A. In other words, tapered ramps 36 define a relatively larger cross-section plug portion, proximate shoulder 34, and a relatively smaller cross-section plug portion, distal shoulder 34.

The number of tapered ramps 36 is selected at least partially based on and corresponds with, for example, the particular configuration of the remainder of draw wedge fastener assembly 10. For example, embodiments of anchor body 30A, 30B which include three sidewalls further include e.g. three tapered ramps. Embodiments of anchor body 30A, 30B which include four sidewalls further include e.g. four tapered ramps.

In some embodiments such as those of FIGS. 4A, 4B, 4C, 6A, and others, three tapered ramps are utilized. In such embodiments, first and second ones of tapered ramps 36 extend in generally parallel directions, with the respective tapered surface tapering outwardly and downwardly toward the other one of the two generally parallel tapered ramps 36. The third tapered ramp 36 extends generally perpendicularly between and connects the first and second tapered ramps 36.

In embodiments which utilize three tapered ramps, each of the two generally parallel tapered ramps 36 has a tapered upper edge surface, namely tapered ramp edge 36A (FIG. 6A). Accordingly, the two tapered ramp edges 36A of the two generally parallel tapered ramps 36, in combination, generally define a fourth tapered ramp surface with a void extending therethrough.

In some embodiments, anchor body 30A, 30B includes four, continuous, tapered ramp surfaces, i.e. four tapered ramps 36. Exemplary of and anchor body with four tapered ramps 36 is the four-walled anchor body 30A of FIG. 3B. Namely, anchor body 30A which is vertically positioned, and points upwardly, in FIG. 3B, includes four ramps 36, although only two of the four ramps 36 are visible.

Regardless of the particular number of tapered ramps 36 and/or tapered ramp edges 36A, the outer surface of the combination of ones of the tapered ramps is sized, configured, and/or has other characteristics, selected at least in part to suitably interface, slidingly or otherwise, with the inwardly facing surfaces of ramp tabs 26 of draw plug 20A, 20B, 20C, whereby the respective draw plugs and anchor bodies are adapted and configured to cooperate with each other. Namely, ones of ramp tabs 26 of draw plug 20A, 20B, 20C slidingly interface, in face to face communication, with corresponding and respective ones of tapered ramps 36 of anchor body 30A, 30B.

Preferably, tapered ramps 36 in combination define a rectangular, square, or other straight-sided, perimeter and ramp tabs 26 and thus pocket cavity 130 also define a rectangular, square, or other straight-sided perimeter. Accordingly, when in use, the interfacing potions of the respective corners at each of the rectangular, square, or other straight-sided perimeters of the draw plug 20A, 20B, 20C and anchor body 30A, 30B mechanically interface so as to resist torsional forces and radial movement or rotation of draw plug 20A, 20B, 20C as it axially advances up anchor body 30A, 30B.

Anchor body assembly 40A defines a generally pyramidal, or partially cuboidal, structure with, for example, three projecting elements e.g. anchor bodies 30A projecting therefrom. Namely, bottom wall 45 of anchor body 40A is generally planar, has upper and lower surfaces, and is generally rectangular or square, or a modified square of modified rectangle, when viewed from above.

Each of gussets 50 are generally planar extension which extend upwardly, and generally perpendicularly, from the upper surface of bottom wall 45. Four gussets, e.g. two pairs of gussets 50, are exemplarily illustrated projecting upwardly from bottom wall 45. Each pair of gussets 50 includes one inwardly disposed gusset which is proximate the interior, inwardly facing, surface of tubing assembly 1, and one outwardly disposed gusset which is proximate the exterior, outwardly facing, surface of tubing assembly 1, and generally define a channel therebetween e.g. between the respective inwardly and outwardly disposed gussets 50 within each pair.

The two outwardly disposed gussets 50 each have an inwardly facing surface and an outwardly facing surface. The two outwardly disposed gussets 50 generally intersect each other, either directly or by projection, and generally define an outermost, outwardly facing, corner of anchor body assembly 40A. Thus, the outer facing surfaces of the two outwardly disposed gussets 50, at least partially define corresponding outwardly facing surfaces of anchor body assembly 40A, generally perpendicular to each other.

The two inwardly disposed gussets 50 each have an inwardly facing surface and an outwardly facing surface. The two inwardly disposed gussets 50 generally intersect each other, either directly or indirectly, and generally define an inwardly facing corner of anchor body assembly 40A. Thus the inwardly facing surfaces of the two inwardly disposed gussets 50, at least partially define corresponding inwardly facing surfaces of anchor body assembly 40A, generally perpendicular to each other.

Referring now to FIGS. 4A and 6, and various other suitable configurations of anchor body assemblies, in some embodiments, such as anchor body assembly 40B, the anchor body assembly is integral with, and extends from, anchor body 30A. As exemplarily illustrated, anchor body assembly 40B extends generally coaxially from anchor body 30A. In some embodiments, an extension, e.g. anchor body assembly 40C, extends generally coaxially from anchor body 30A and body assembly 40B. In other embodiments, an extension, e.g. body assembly 40D, extends perpendicularly away from anchor body 30A and/or anchor body assembly 40B.

Terminal ends of anchor body assemblies 40B, 40C, 40D, include anchor bodies 30A for use in conjunction with draw plugs 20A, 20B, 20C. Or, the terminal ends of anchor body assemblies 40B, 40C, 40D can be, as desired, adapted and configured for direct connection to tubing members, for example without use of draw plugs 20A, 20B, 20C, by e.g. press fit, friction fit, or otherwise.

Regardless of the exact structure and configuration of anchor body assemblies 40A, 40B, 40C, 40D, ones of the anchor body assemblies are adapted and configured to enable easy, straight line approach, access to e.g. the head of bolt “B” with a corresponding tool. As one example, the outermost end walls of anchor body assemblies 40A, 40B, 40C, 40D include a recess, through bore, depression, void, and/or other typical hardware access structure which enables a user to relatively easily manipulate bolts “B” with the corresponding, appropriate tools, e.g. screwdrivers, nut drivers, hex wrenches, and/or others.

Referring now to FIGS. 2 and 3, tubing members, including but not limited to, top tubing members T1, T2, T3, T4, bottom tubing members BT1, BT2, BT3, BT4, and upright tubing members U1, U2, U3, U4, define numerous profiles, structures, and/or other configurations which correspond to the particular intended use environments. Two different such exemplary profiles are illustrated in FIGS. 2 and 3. Namely, bottom tubing member BT4 and upright tubing member U4 realize a first tubing profile and bottom tubing member BT3 realizes a second, different, tubing profile.

Bottom tubing member BT4 and upright tubing member U4 each include a nominally intersecting opening, e.g. opening 65A, 65B, which extends axially therethrough. Bottom and upright tubing members BT4, U4 each has a double valley channel 66A, 66B, and a single valley channel 68A, 68B. Each of bottom and upright tubing members BT4, U4 generally defines an L-shaped extrusion. Namely, double valley channels 66A, 66B and single valley channels 68A, 68B each extend outwardly away from respective ones of openings 65A, 65B, and generally perpendicularly away from each other.

Double valley channels 66A, 66B each have an innermost wall, which communicates with openings 65A and 65B respectively, and three legs which extend outwardly from the innermost wall and which extend along the length of bottom and upright tubing members BT4, U4. Namely, two lateral legs of double valley channels 66A, 66B extend along the length of bottom and upright tubing members BT4, U4, and generally define the outermost, lateral, surfaces of double valley channels 66A, 66B. Each of the terminal ends of the double valley channel lateral legs has an inwardly extending projection, which extends along the full length of the respective leg, and inwardly into the double valley channel 66A, 66B, e.g. toward the other one of the lateral legs.

A third, medial, leg extends along the lengths of bottom and upright tubing members BT4, U4, between the lateral legs. The terminal end of the medial leg has two outwardly extending projections, which extend toward respective ones of the lateral legs.

Single valley channels 68A, 68B each have an innermost wall, which communicates with openings 65A and 65B respectively, and two legs which extend outwardly from the innermost wall and extend along the length of bottom and upright tubing members BT4, U4. Namely, two lateral legs of each of single valley channels 68A, 68B extend along the length of bottom and upright tubing members BT4, U4, and generally define the outermost, lateral, surfaces of single valley channels 68A, 68B. Each of the outermost terminal ends of the single valley channel lateral legs has an inwardly extending projection, which extends along the full length of the respective leg, and inwardly into the single valley channel 68A, 68B, e.g. toward the other one of the lateral legs.

Bottom tubing member BT3 includes an opening, e.g. opening 65C, which extends axially therethrough. Bottom tubing member BT3 has two, single valley channels 66C, 68C. The entire assemblage of bottom tubing member BT3 generally defines an L-shaped extrusion. Namely, the two single valley channels 66C, 68C each extend outwardly away from opening 65C, and generally perpendicularly away from each other.

Single valley channels 66C, 68C each have an innermost wall, which communicates with opening 65C, and two lateral legs which extend outwardly therefrom. The two lateral legs extend along the length of bottom tubing member BT3. Namely, two lateral legs of single valley channels 66C, 68C extend along the length of bottom tubing member BT3 and generally define the outermost, lateral, surfaces of single valley channels 66C, 68C. Each of the outermost terminal ends of the single valley channel lateral legs has an inwardly extending projection, which extends along the full length of the respective leg, and inwardly into the respective single valley channel 66C, 68C, e.g. toward the other one of the respective lateral legs.

Ones of the tubing members, e.g. top tubing members T1, T2, T3, T4, bottom tubing members BT1, BT2, BT3, BT4, and upright tubing members U1, U2, U3, U4, separately and/or in combination, are adapted and configured to hold, restrain, mount, grasp, receive, house, and/or otherwise contain, at least part of ones of the enclosure panels or walls of tubing assembly 1, including, but not limited to, top wall “TW,” bottom wall “BW,” sidewalls S1, S2, S3, and door panels DP.

Namely, the valleys of the double valley channels 66A, 66B and the valleys of the single valley channels 68A, 68B, 66C, 68C define, for example, valley opening width, length, and depth dimensions, and valley surface characteristics, which correspond to the dimensions and surface characteristics of respective ones of top wall “TW,” bottom wall “BW,” sidewalls S1, S2, S3, and door panels DP. Thus, ones of top wall “TW,” bottom wall “BW,” sidewalls S1, S2, S3, and door panels DP can be axially slidingly received into, laterally slidingly received into, snap-lockingly received into, and/or otherwise received into or housed in respective valleys defined by the channels defined in top tubing members T1, T2, T3, T4, bottom tubing members BT1, BT2, BT3, BT4, and/or upright tubing members U1, U2, U3, U4, as desired.

FIG. 4A shows an exploded view of a second embodiment of draw-wedge fastener assemblies 10 of the invention which includes draw plug 20A, anchor body 30A integral with anchor body assembly 40B, bolt “B,” washer “W,” and tubing member 60. Tubing member 60 defines yet another distinct tubing profile and configuration suitable for use with various draw-wedge fastener assemblies of the invention. Opening 65D extends axially through the length of tubing member 60. Flange 66D extends laterally outwardly from the main body of tubing member 60, e.g. away from opening 65D. Draw-wedge fastener assembly 10 is adapted and configured to be inserted into opening 65D and to correspondingly frictionally grip tubing 60.

Referring now to FIGS. 2A, 3A, 4A, 8, and 9, openings 65A, 65B, 65C, and 65D are each adapted and configured to accept draw plug 20A, anchor body 30A, bolt “B,” washer “W,” and/or other ones of the components of anchor body assemblies 40A, 40B, 40C, 40D therein. Namely, the elongate inwardly facing wall surfaces of the tubing, which generally define the outermost perimeters of openings 65A, 65B, 65C, and 65D provide generally rigid interface structure against which the expandable terminal ends of draw plug 20A can frictionally, mechanically, brakingly, or otherwise interfacingly, communicate with.

In some embodiments, the elongate inwardly facing wall surfaces of the openings include elongate projections or ribs, extending along the length thereof and into openings 65A, 65B, 65C, and 65D. In such embodiments, each inwardly facing wall surface includes a pair of elongate projections or ribs thereon. The ribs in a respective pair of ribs are spaced from each other by a distance which corresponds to, for example, the magnitude of the width dimension of plug sidewall 120, whereby the ribs generally serve an alignment and guiding function as draw plug 20A, 20B, 20C is inserted into the tubing member.

The corresponding configurations of ones of 65A, 65B, 65C, and 65D and draw plug 20A, anchor body 30A, bolt “B,” washer “W,” and/or other ones of the components of anchor body assemblies 40A, 40B, 40C, 40D, enables draw plug 20A to generally resist non-desired withdrawal of draw plug 20A from respective ones of openings 65A, 65B, 65C, and 65D.

The openings 65A, 65B, 65C, and 65D are sized, adapted and configured to correspond to e.g. the size and surface characteristics of draw plug 20A, 20B, 20C. As one example, in some embodiments, openings 65A, 65B, 65C, and 65D are generally, rectangular, square, or other straight-sided shaped, in cross section. Correspondingly, e.g. draw plugs 20A, 20B defines generally, rectangular, square, or other straight-sided shaped, cross sectional perimeters.

Accordingly, when in use, the interfacing potions of the respective corners at each of the rectangular, square, or other straight-sided perimeters of the openings 65A, 65B, 65C, and 65D and draw plugs 20A, 20B mechanically interface so as to resist torsional forces and radial movement or rotation of draw plug 20A, 20B, as the draw plug is inserted into and/or housed therein. Resisting torsional forces and radial movement or rotation of draw plug 20A, 20B within the tubing member can be supplemented, as desired, by utilizing tubing members which include inner surfaces with elongate projections or ribs to relatively increase the amount of mechanical interfacing between the tubing and the draw plug.

To use draw-wedge fastener assemblies 10 of the invention, a user inserts bolt “B” through washer “W,” then through smooth bore 32 of anchor body 30A. Washer “W” and/or the inwardly facing surface of the head of bolt “B” interface with shoulder 34 which mechanically prevents bolt “B” from moving longitudinally through anchor body 30A e.g. as the bolt is tightened. Since the smooth bore 32 is generally not threaded, bolt “B” is free to rotate, generally without restraint, within anchor body 30A.

The threads of bolt “B” mechanically engage the corresponding threads of threaded bore 22 of draw plug 20A. As the user tightens bolt “B,” the threaded engagement between bolt “B” and draw plug 20A draws, pulls, and/or otherwise advances, the plug 20A nearer anchor body 30A, e.g. draw plug 20A and anchor body 30A are axially advanced toward each other. Correspondingly, the inner surfaces of ramp tabs 26, namely ramped surfaces 26A, interface with the outer surfaces of tapered ramps 36.

As draw plug 20A advances toward anchor body 30A, ramp tabs 26 slide, climb, or flex, progressively further up and over tapered ramps 36, whereby ramp tabs 26 extend, flare, flex, deflect, and/or otherwise expand, outwardly. Thus, when ramp tabs 26 are in this outwardly flared condition, the portion of draw-wedge fastener assembly 10 adjacent the ramp tabs 26 is relatively radially expanded as the ramp tabs are flexed or otherwise urged outwardly against, and mechanically and frictionally interface with, and engage, the inner surfaces of the tubing member at the perimeter of the respective opening 65A, 65B, 65C, and/or 65D.

As bolt “B” advances through draw plug 20A beyond threaded bore 22, the bolt enters and communicates with end bore 23. Since the diameter of the end bore 23 is of lesser magnitude that the magnitude of threaded bore 22, and/or since end bore 23 conically tapers to a lesser diameter (FIG. 7B), and is also less than the magnitude of the diameter of bolt “B”, when bolt “B” advances through end bore 23, end bore 23 expands radially under the axially advancing force of bolt “B.” As the diameter of end bore 23 increases in magnitude to enables bolt “B” to pass through the end bore, the insert tabs 24 correspondingly radially extend, flare, and/or otherwise expand, radially outwardly.

When insert tabs 24 are in this outwardly flared condition, the portion of draw-wedge fastener assembly 10 adjacent the insert tabs 24 is relatively radially expanded and the insert tabs mechanically interface the inner surfaces of the tubing member which defines the outer perimeter of openings 65A, 65B, 65C, and 65D.

The expanded regions of draw-wedge fastener assembly 10 namely (i) at insert tabs 24 and (ii) at ramp tabs 26, in other words the expanded ends 110, 112, effectively lock, wedge, frictionally engage, or otherwise securingly interface the plug assembly in the tubing opening. This is realized by way of expansion ramps, which form angles with the longitudinal axes, wherein the angles have apexes pointing in generally opposing directions, namely toward each other. Accordingly, the simultaneous expansion of both ends of draw plug 20A enables the fastener assembly 10, 10 to lockingly engage the respective tubing member, at least partially through the cooperation and frictional engagement between draw plug 20A and the respective one of openings 65A, 65B, 65C, and/or 65D.

In other words, a user can advance a single actuator, bolt “B,” along a generally longitudinal axis and correspondingly actuates draw plug 20A at at least first and second spaced loci along the length of draw plug 20A. The resultant, in use, configuration is a draw plug with first and second flared or expanded ends, wherein each of the first and second ends defines a relatively most expanded portion at its respective point of terminus, and tapers downwardly from the respective most expanded portion toward the main body portion of the draw plug which is of relatively constant cross sectional width along the length thereof.

Preferably, tubing assembly 1 is made of materials which resist corrosion, and are suitably strong and durable for normal extended use. Those skilled in the art are well aware of certain metallic and non-metallic materials which possess such desirable qualities, and appropriate methods of forming such materials.

Appropriate metallic materials for components of tubing assembly 1 include, but are not limited to, anodized aluminum, aluminum, steel, stainless steel, titanium, magnesium, brass, and their respective alloys. Common industry methods of forming such metallic materials include casting, forging, shearing, bending, machining, riveting, welding, powdered metal processing, extruding and others.

Non-metallic materials suitable for components of tubing assembly 1, e.g. draw plug 20A, anchor body 30A, anchor body assemblies 40A, 40B, 40C, 40D, bottom cap 50, cap projection 57, various parts of castor “C,” and others, are various polymeric compounds, such as for example and without limitation, various of the polyolefins, such as a variety of the polyethylenes, e.g. high density polyethylene, or polypropylenes. There can also be mentioned as examples such polymers as polyvinyl chloride and chlorinated polyvinyl chloride copolymers, various of the polyamides, polycarbonates, and others.

For any polymeric material employed in structures of the invention, any conventional additive package can be included such as, for example and without limitation, slip agents, anti-block agents, release agents, anti-oxidants, fillers, and plasticizers, to control e.g. processing of the polymeric material as well as to stabilize and/or otherwise control the properties of the finished processed product, also to control hardness, bending resistance, and the like.

Common industry methods of forming such polymeric compounds will suffice to form non-metallic components of tubing assemblyl. Exemplary, but not limiting, of such processes are the various commonly-known plastics converting processes.

Tubing assembly is preferably manufactured as individual components, and the individual components assembled as sub-assemblies, including but not limited to, tubing frame 2, draw-wedge fastener assembly 10, and others. Each of the aforementioned sub-assemblies is then assembled to respective other ones of the sub-assemblies to develop tubing assembly 1.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A draw-wedge fastener, comprising:
(a) an anchor body having a length and a bore extending therethrough, along the length thereof;
(b) a draw plug having a length, first and second ends, and a bore extending therethrough, along the length thereof; the bore of said draw plug generally coaxially aligned with the bore of said anchor body; and
(c) a bolt having a bolt head and a length and extending axially through the entire length of the bore of said anchor body and at least partially through the length of the bore of said draw plug; and
wherein said anchor body is positioned generally between said draw plug and said bolt head, said draw plug movable between a first position and a second position, when said draw plug is in such first position, said draw plug is relatively axially regressed with respect to said anchor body and when said draw plug is in such second position, said draw plug is relatively axially advanced with respect to said anchor body, said draw plug in said second position generally defining relatively outwardly flared first and second ends.

2. A draw-wedge fastener as in claim 1 wherein at least one of said first and second ends of said draw plug has a recess extending axially thereinto.

3. A draw-wedge fastener as in claim 2 wherein said anchor body includes a tapered end, said end recess of said draw wedge fastener adapted and configured to slidingly receive said tapered end of said anchor body therein.

4. A draw-wedge fastener as in claim 1 wherein one of said first and second ends of said draw plug includes a plurality of deflectable tabs extending axially therefrom.

5. A draw-wedge fastener as in claim 1, said draw-wedge fastener inserted into a piece of tubing and wherein each of said first and second ends of said draw plug interfaces an inner circumferential surface of such piece of tubing.

6. A draw-wedge fastener as in claim 1 wherein at least one of said first and second ends of said draw plug has void extending axially thereinto, such void defining an outer perimeter which is generally defined by a plurality of elongate ramped surfaces.

7. A draw-wedge fastener as in claim 6 wherein ones of said plurality of ramped surfaces are generally deflectable.

8. A draw-wedge fastener, comprising:
(a) an anchor body having a length, a bore extending axially therethrough, and first and second ends, said first end of said anchor body defining a generally planar shoulder thereupon which is generally perpendicular to said bore, said second end defining a generally tapering outer surface thereof;
(b) a draw plug adapted and configured to axially advance toward and regress from said anchor body, having a length, first and second ends, and a bore extending therethrough, each of said first and second ends of said draw plug being radially expandable,
(c) a bolt having extending axially and rotatably through said anchor body and axially into said draw plug,
said bolt mechanically engaging said draw plug so that when said bolt is rotated in a first direction of rotational travel, said draw plug axially advances toward said anchor body and when said bolt is rotated in a second, opposite, direct of rotational travel, said draw plug axially regresses from said anchor body.

9. A draw-wedge fastener as in claim 8 wherein at least one of said first and second ends of said draw plug has a recess extending axially thereinto, said end recess of said draw wedge fastener adapted and configured to receive said tapering outer surface of said anchor body therein.

10. A draw-wedge fastener as in claim 9 wherein said draw wedge fastener adapted and configured to slidingly receive said tapering outer surface of said anchor body therein.

11. A draw-wedge fastener as in claim 8 wherein one of said first and second ends of said draw plug includes a plurality of resiliently flexible tabs extending therefrom.

12. A draw-wedge fastener as in claim 8, said draw-wedge fastener inserted into a piece of tubing and wherein each of said first and second ends of said draw plug interfaces an inner circumferential surface of such piece of tubing.

13. A tubing assembly comprising a draw-wedge fastener as in claim 8.

14. A tubing assembly as in claim 13 wherein said tubing assembly is an animal housing enclosure.

15. A tubing assembly as in claim 13 wherein said tubing assembly is a table.

16. A draw-wedge fastener, comprising:
(a) an anchor body having a length, a bore extending axially therethrough, and a generally tapered end;
(b) a draw plug having a length, a bore extending axially therethrough, and first and second ends; and
(c) a bolt having extending axially and rotatably through said anchor body and axially into said draw plug,
said first end of said draw plug having a recess extending thereinto, said recess adapted and configured to slidingly accept said generally tapered end of said anchor body therein, said second end of said draw plug including a plurality of deflectable tabs extending axially outwardly therefrom.

17. A draw-wedge fastener as in claim 16, said bolt mechanically engaging said draw plug so that when said bolt is rotated in a first direction of rotational travel, said draw plug axially advances toward said anchor body and when said bolt is rotated in a second, opposite, direct of rotational travel, said draw plug axially regresses from said anchor body.

18. A draw-wedge fastener as in claim 16, said recess defining an outer which is generally defined by a plurality of elongate ramped surfaces.

19. A tubing assembly comprising a draw-wedge fastener as in claim 16.

20. A tubing assembly as in claim 19 wherein said tubing assembly is an animal housing enclosure.
